(19) United States
(12) Patent Application Publication
(10) Pub. No.: US 2014/0176023 A1
(43) Pub. Date: Jun. 26, 2014

(54) MOTOR DRIVING APPARATUS AND SYSTEM

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: JIAN ZHAO, Wuhan (CN); CHONG HE, Wuhan (CN); XIAO-HUI WANG, Wuhan (CN); WEN-JUN HU, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/972,333

(22) Filed: Aug. 21, 2013

(30) Foreign Application Priority Data
Dec. 24, 2012 (CN) 2012105653081

(51) Int. Cl. H02P 1/54

(52) U.S. Cl. CPC H02P 1/54
USPC 318/51

(57) ABSTRACT

A motor driving system includes a first driving controller, a second driving controller, a first motor, a second motor, a third motor, and a fourth motor. The first motor is electrically connected to the first output terminals of the first and the second driving controllers. The second motor is electrically connected to the third output terminal of the first driving controller and the second output terminal of the second driving controller. The third motor is electrically connected to the second output terminal of the first driving controller and the third output terminal of the second driving controller. The fourth motor is electrically connected to the fourth output terminals of the first and the second driving controllers. The first and the second driving controllers receive control signals, and drive the first, the second, the third, and the fourth motors to rotate according to the control signals.

### BACKGROUND

1. Technical Field

The present disclosure relates to a motor driving apparatus and system.

2. Description of Related Art

Motors are used in vending machines to push items for sale to an output tray, and customers can reach the items from the output tray. Each motor is driven by a separate MOSFET to rotate. When a number of the motors increases, a great number of MOSFETs are needed to drive the motors, such a configuration may increase costs of the vending machines.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a circuit diagram of an embodiment of a motor driving apparatus.

FIG. 2 is a block diagram of a motor driving system using the driving controller of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

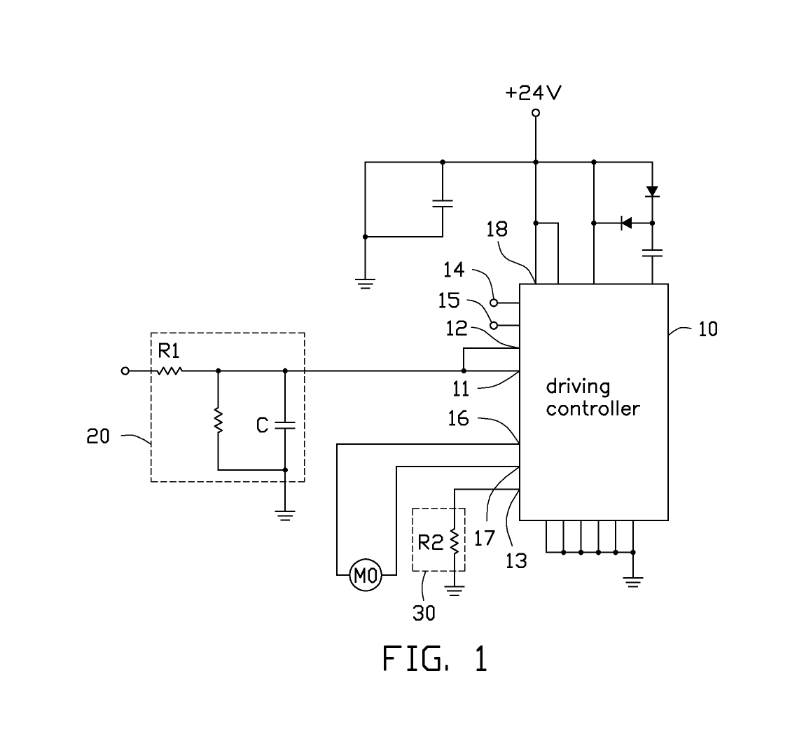

FIG. 1 shows a motor driving apparatus of the embodiment. The motor driving apparatus includes a driving controller 10, a delay circuit 20, an over-current protecting unit 30, and a motor M0.

The driving controller 10 includes a driving terminal 11, an over-current control terminal 12, an over-current protecting terminal 13, a first input terminal 14, a second input terminal 15, a first output terminal 16, a second output terminal 17, and a voltage input terminal 18.

The delay circuit 20 includes a first resistor R1 and a capacitor C. The driving terminal 11 receives a motor drive signal via the first resistor R1. The driving terminal 11 is grounded via the capacitor C. The over-current control terminal 12 is electrically connected to the driving terminal 11.

The over-current protecting unit 30 includes a second resistor R2. The over-current protecting terminal 13 is grounded via the second resistor R2. The first input terminal 14 receives a first control signal. The second input terminal 15 receives a second control signal. The first output terminal 16 is electrically connected to an anode of the motor M0. The second output terminal 17 is electrically connected to a cathode of the motor M0. The first output terminal 16 and the second output terminal 17 output a first DC voltage to provide power supply for the motor M0. The voltage input terminal 18 receives a second DC voltage. In one embodiment, a resistance of the first resistor R1 is 51 kilo ohm. A capacitance of the capacitor C is 100 nano farad. A response time of the delay circuit 20 is 1 millisecond. A resistance of the second resistor R2 is 12.1 kilo ohm. An over-current protecting value of the driving controller 10 is 1 ampere. The first DC voltage and the second DC voltage are +24V.

In operation, the driving terminal 11 receives a high voltage level motor drive signal via the first resistor R1. The first input terminal 14 receives the first control signal. The second input terminal 15 receives the second control signal. When the first control signal is a high voltage level and the second control signal is a low voltage level, the first output terminal 16 outputs a +24V voltage signal, the second output terminal 17 outputs a 0V voltage signal, the motor M0 receives a +24V first DC voltage and rotates along a first direction. When the first control signal is a low voltage level and the second control signal is a high voltage level, the first output terminal 16 outputs a 0V voltage signal, the second output terminal 17 outputs a +24V voltage signal, the motor M0 receives a −24V first DC voltage and rotates along a second direction opposite to the first direction.

When the first control signal and the second control signal are both high voltage levels, the first output terminal 16 and the second output terminal 17 both output the+24V voltage signal, the motor M0 receives a 0V first DC voltage and stops rotating. When the first control signal and the second control signal are both low voltage levels, the first output terminal 16 and the second output terminal 17 both output the 0V voltage signal, the motor M0 receives a 0V first DC voltage and stops rotating. When the driving terminal 11 receives a low voltage level motor drive signal via the first resistor R1, the first output terminal 16 and the second output terminal 17 both have no voltage signal output no matter high voltage level or low voltage level of the first control signal and the second control signal, the motor M0 is idle.

In one embodiment, the response time of the delay circuit 20 is variable by adjusting the resistance of the first resistor R1 and the capacitance of the capacitor C. The over-current protecting value of the driving controller 10 is variable by adjusting the resistance of the second resistor R2. When a current flows through the driving controller 10 exceeds the over-current protecting value, the over-current control terminal 12 outputs a low voltage level over-current control signal, the driving terminal 11 receives the low voltage level motor drive signal, the driving controller 10 has no voltage signal output to protect the motor M0.

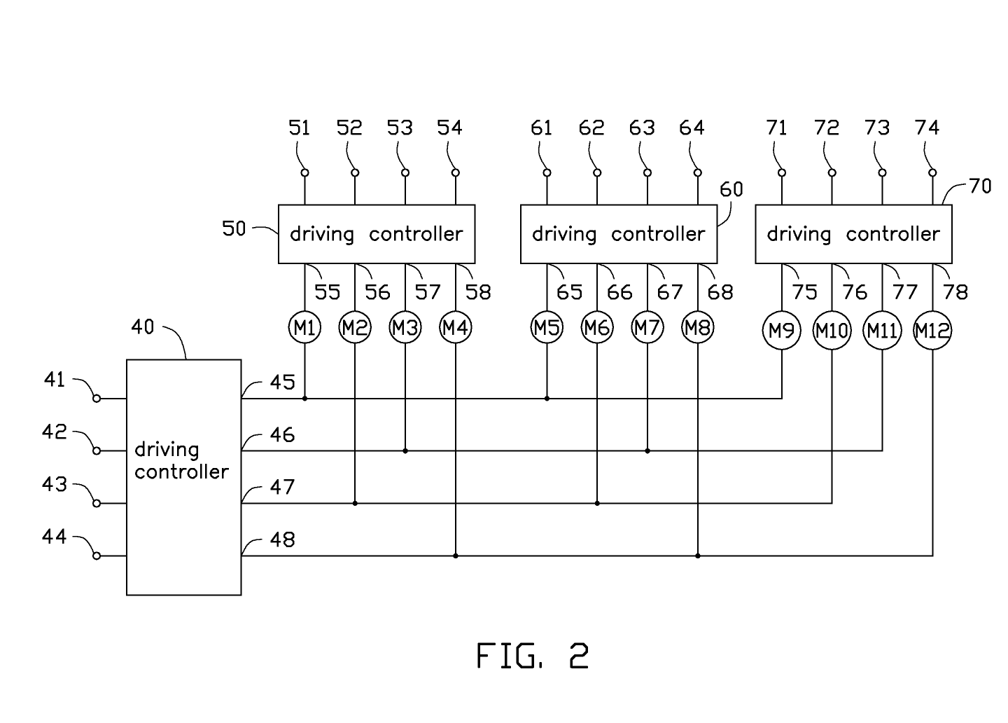

FIG. 2 shows a motor driving system includes a plurality of driving controllers 40-70 and motors M1-M12. The driving controller 40 includes a first input terminal 41, a second input terminal 42, a third input terminal 43, a fourth input terminal 44, a first output terminal 45, a second output terminal 46, a third output terminal 47, and a fourth output terminal 48. The driving controller 50 includes a first input terminal 51, a second input terminal 52, a third input terminal 53, a fourth input terminal 54, a first output terminal 55, a second output terminal 56, a third output terminal 57, and a fourth output terminal 58.

The driving controller 60 includes a first input terminal 61, a second input terminal 62, a third input terminal 63, a fourth input terminal 64, a first output terminal 65, a second output terminal 66, a third output terminal 67, and a fourth output terminal 68. The driving controller 70 includes a first input terminal 71, a second input terminal 72, a third input terminal 73, a fourth input terminal 74, a first output terminal 75, a second output terminal 76, a third output terminal 77, and a fourth output terminal 78.

An anode an a cathode of the motor M1 are electrically connected to the first output terminal 45 of the driving controller 40 and the first output terminal 55 of the driving controller 50 respectively. An anode an a cathode of the motor M2 are electrically connected to the third output terminal 47 of the driving controller 40 and the second output terminal 56 of the driving controller 50 respectively. An anode an a cathode of the motor M3 are electrically connected to the second output terminal 46 of the driving controller 40 and the third output terminal 57 of the driving controller 50 respectively. An anode an a cathode of the motor M4 are electrically connected to the fourth output terminal 48 of the driving controller 40 and the fourth output terminal 58 of the driving controller 50 respectively.

An anode an a cathode of the motor M5 are electrically connected to the first output terminal 45 of the driving controller 40 and the first output terminal 65 of the driving controller 60 respectively. An anode an a cathode of the motor M6 are electrically connected to the third output terminal 47 of the driving controller 40 and the second output terminal 66 of the driving controller 60 respectively. An anode an a cathode of the motor M7 are electrically connected to the second output terminal 46 of the driving controller 40 and the third output terminal 67 of the driving controller 60 respectively. An anode an a cathode of the motor M8 are electrically connected to the fourth output terminal 48 of the driving controller 40 and the fourth output terminal 68 of the driving controller 60 respectively.

An anode an a cathode of the motor M9 are electrically connected to the first output terminal 45 of the driving controller 40 and the first output terminal 75 of the driving controller 70 respectively. An anode an a cathode of the motor M10 are electrically connected to the third output terminal 47 of the driving controller 40 and the second output terminal 76 of the driving controller 70 respectively. An anode an a cathode of the motor M11 are electrically connected to the second output terminal 46 of the driving controller 40 and the third output terminal 77 of the driving controller 70 respectively. An anode an a cathode of the motor M12 are electrically connected to the fourth output terminal 48 of the driving controller 40 and the fourth output terminal 78 of the driving controller 70 respectively.

When the first input terminal 41 of the driving controller 40 receives the low voltage level first control signal, and when the first input terminal 51 of the driving controller 50 receives the high voltage level first control signal, the motor M1 receives the +24V first DC voltage and rotates along the first direction. When the first input terminal 41 of the driving controller 40 receives the high voltage level first control signal, and when the first input terminal 51 of the driving controller 50 receives the low voltage level first control signal, the motor M1 receives the −24V first DC voltage and rotates along the second direction. In a manner similar to the motor M1, the motors M2-M12 rotate along the first direction or the second direction according to the first control signals received by the input terminals of the driving controllers 40-70.

The motor driving system is not limited to drive the motors M1-M12 in the above embodiment, the motor driving system can drive a plurality of motors with more driving controllers parallel connected with the driving controllers 50-70. Four additional motors can be connected to the motor driving system with one driving controller added. Therefore, a number of the driving controllers is decreased which decreases the costs.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A motor driving system, comprising:
a first driving controller and a second driving controller, each of the first and the second driving controller having a first output terminal, a second output terminal, a third output terminal, and a fourth output terminal; and
a first motor, a second motor, a third motor, and a fourth motor; the first motor being electrically connected to the first output terminals of the first and the second driving controllers; the second motor being electrically connected to the third output terminal of the first driving controller and the second output terminal of the second driving controller; the third motor being electrically connected to the second output terminal of the first driving controller and the third output terminal of the second driving controller; and the fourth motor being electrically connected to the fourth output terminals of the first and the second driving controllers;
wherein the first and the second driving controllers are adapted to receive control signals, and drive the first, the second, the third, and the fourth motors to rotate according to the control signals.

2. The motor driving system of claim 1, further comprising a third driving controller, a fifth motor, a sixth motor, a seventh motor, and an eighth motor; the third driving controller comprises a first output terminal, a second output terminal, a third output terminal, and a fourth output terminal; each of the fifth, the sixth, the seventh, and the eighth motors comprises an anode and a cathode; the anode and the cathode of the fifth motor are electrically connected to the first output terminals of the first and the third driving controllers; the anode and the cathode of the sixth motor are electrically connected to the third output terminal of the first driving controller and the second output terminal of the third driving controller; the anode and the cathode of the seventh motor are electrically connected to the second output terminal of the first driving controller and the third output terminal of the third driving controller; and the anode and the cathode of the eighth motor are electrically connected to the fourth output terminals of the first and the third driving controllers.

3. The motor driving system of claim 2, wherein each of the first, the second, and the third driving controllers further comprises a first input terminal, a second input terminal, a third input terminal, and a fourth input terminal; the first, the second, the third, and the fourth input terminals are adapted to receive the control signals.

4. The motor driving system of claim 3, further comprising a delay circuit and an over-current protecting unit; each of the first, the second, and the third driving controllers further comprises a driving terminal and an over-current protecting terminal; the driving terminal receives a motor drive signal via the delay circuit; and the over-current protecting terminal is grounded via the over-current protecting unit.

5. The motor driving system of claim 4, wherein the delay circuit comprises a first resistor and a capacitor; the driving terminal receives the motor drive signal via the first resistor; and the driving terminal is grounded via the capacitor.

6. The motor driving system of claim 3, wherein each of the first, the second, and the third driving controllers further comprises an over-current control terminal; and the over-current control terminal is electrically connected to the driving terminal

7. The motor driving system of claim 3, wherein each of the first, the second, and the third driving controllers further comprises a voltage input terminal; and the voltage input terminal receives a second DC voltage.

8. The motor driving system of claim 3, wherein a voltage level of the first output terminal is same as a voltage level of the first input terminal; a voltage level of the second output terminal is same as a voltage level of the second input terminal; a voltage level of the third output terminal is same as a voltage level of the third input terminal; and a voltage level of the fourth output terminal is same as a voltage level of the fourth input terminal.

9. A motor driving system, comprising:
a first driving controller and a second driving controller, each of the first and the second driving controller having a first input terminal, a second input terminal, a third input terminal, a fourth input terminal, a first output terminal, a second output terminal, a third output terminal, and a fourth output terminal; and
a first motor, a second motor, a third motor, and a fourth motor, each of the first, the second, the third, and the fourth motors has an anode and a cathode; the anode the a cathode of the first motor being electrically connected to the first output terminals of the first and the second driving controllers; the anode and the cathode of the second motor being electrically connected to the third output terminal of the first driving controller and the second output terminal of the second driving controller; the anode and the cathode of the third motor being electrically connected to the second output terminal of the first driving controller and the third output terminal of the second driving controller; the anode and the cathode of the fourth motor being electrically connected to the fourth output terminals of the first and the second driving controllers;
wherein the first, the second, the third, and the fourth input terminals are adapted to receive control signals; and the first driving controller and the second driving controller drive the first, the second, the third, and the fourth motors to rotate according to the control signals.

10. The motor driving system of claim 9, further comprising a third driving controller, a fifth motor, a sixth motor, a seventh motor, and an eighth motor; the third driving controller comprises a first output terminal, a second output terminal, a third output terminal, and a fourth output terminal; each of the fifth, the sixth, the seventh, and the eighth motors comprises an anode and a cathode; the anode and the cathode of the fifth motor are electrically connected to the first output terminals of the first and the third driving controllers; the anode and the cathode of the sixth motor are electrically connected to the third output terminal of the first driving controller and the second output terminal of the third driving controller; the anode and the cathode of the seventh motor are electrically connected to the second output terminal of the first driving controller and the third output terminal of the third driving controller; and the anode and the cathode of the eighth motor are electrically connected to the fourth output terminals of the first and the third driving controllers.

11. The motor driving system of claim 9, further comprising a delay circuit and an over-current protecting unit; each of the first, the second, and the third driving controllers further comprises a driving terminal and an over-current protecting terminal; the driving terminal receives a motor drive signal via the delay circuit; and the over-current protecting terminal is grounded via the over-current protecting unit.

12. The motor driving system of claim 11, wherein the delay circuit comprises a first resistor and a capacitor; the driving terminal receives the motor drive signal via the first resistor; and the driving terminal is grounded via the capacitor.

13. The motor driving system of claim 9, wherein each of the first, the second, and the third driving controllers further comprises an over-current control terminal; and the over-current control terminal is electrically connected to the driving terminal

14. The motor driving system of claim 9, wherein each of the first, the second, and the third driving controllers further comprises a voltage input terminal; and the voltage input terminal receives a second DC voltage.

15. The motor driving system of claim 9, wherein a voltage level of the first output terminal is same as a voltage level of the first input terminal; a voltage level of the second output terminal is same as a voltage level of the second input terminal; a voltage level of the third output terminal is same as a voltage level of the third input terminal; and a voltage level of the fourth output terminal is same as a voltage level of the fourth input terminal.
